(19) United States
(12) Patent Application Publication
(10) Pub. No.: US 2011/0037514 A1
(43) Pub. Date: Feb. 17, 2011

(54) Method for the Elimination of Ringing of Power Line Interference Filter

(75) Inventors: Daxue Wei, Nanshan Shenzhen (CN); Yunpeng Liao, Nanshan Shenzhen (CN)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: Edan Instruments, Inc., Nanshan Shenzhen (CN)

(21) Appl. No.: 12/542,147

(22) Filed: Aug. 17, 2009

(51) Int. Cl. H04B 1/10

(52) U.S. Cl. 327/551

(57) ABSTRACT

The present invention discloses a method for the removal of power line interference (PLI) to the signal parts of which are abrupt. First, to the non-abrupt part of the original input signal, we pass it to the notch filter, and get the output as the system output. Then, to the abrupt part, we subtract previous output from the original input signal; and add a straight line, connecting the starting and end of previous output, to the result of the subtraction to get the input of the notch filter. After processing of the notch filter, we add previous output to current output of the notch filter; and subtract the straight line as before from the sum to get the output of this step. We repeat this processing several times. During the detection of electrocardiogram (ECG), 50/60 Hz power line interference conceals the subtle changes in the original ECG, which affects the diagnosis. When the linear time-invariant (LTI) notch filter is used to the suppression of PLI, it usually causes ringing after the QRS complex, which affects the measurement of the Ventricular Late Potential and so on. The present invention uses the starting and end points of the QRS complex to process the input and output signal of the notch filter, so it is able to suppress PLI as well as to avoid the generation of the ringing.

### TECHNICAL FIELD

The present invention relates to the signal processing field, which is specific for

the power line interference filter with the existence of the abrupt signal, particularly refers to the filter method for power line interference component in ECG signals.

### BACKGROUND ART

The ECG signals measured from the skin of human body are weak and often

contaminated by various interferences and noise; the most common one is the power line interference (50 Hz or 60 Hz).

To filter the power line interference is an important problem to be solved during the processing of the ECG signals. At present, digital fillet-technique has been majorly applied to the processing of the power line interference. However, the existing digital notch filter usually generates the ringing phenomenon during the elimination of the power line interference, thus affects the accuracy analysis of the data. FIG. 1 and FIG. 2 show the ringing directly affects the analysis of the late potential during the detection of the ECG signals, and blurs the starting and end points of the QRS complex and T wave, and deforms the T wave.

### CONTENTS OF THE INVENTION

To overcome the ringing of the digital notch filter, the present invention

provides a method for power line interference filter, which is able to eliminate the power line interference, as well as to radically avoid the generation of the ringing.

To achieve the above objective, the present invention adopts the following technical solution:

A method for the removal of power line interference to the signal parts of which are abrupt. First, to the non-abrupt part of the original input signal, we pass it to the notch filter, and get the output as the system output. Then, to the abrupt part, we subtract previous output from the original input signal; and add a straight line, connect the beginning and end of previous output, to the result of the subtraction to get the input of the notch filter. After processing of the notch filter, we add previous output to current output of the notch filter: and subtract the straight line as before from the sum to get the output of this step. We repeat this process several times.

Waveform recognition is used at first to localize the starting and end points of the abrupt parts. To the abrupt signals, the input of the notch filter is given by previous output and original input; the output of the notch filter is adjusted by previous output.

The initial state of the notch filler should be preserved when the original signal, corresponding to the start of the abrupt, pass to the notch filter for the first time.

When the original signals corresponding to the abrupt part are processed to pass to the notch filter, the initial stale of the notch filter should be set as these values.

The original signals corresponding to the abrupt part should be preserved.

The ultimate result of the filter should be regarded as the output of the system.

When the original signals are ECG, the ringing caused by the QRS complex, pace signals and high T-wave can be eliminated.

The benefit of the present invention is able to eliminate the power line interference, as well as to radically avoid the generation of the ringing, which is simple and easy to implement.

### DESCRIPTION OF FIGURES

FIG. 1 shows the original ECG input signal without power line interference;

FIG. 2 shows the output of the signal in FIG. 1 passed to second order 11R notch filter;

FIG. 3 shows the localization of the starting and end points of the QRS complex

in FIG. 1;

FIG.4 shows the first QRS complex and the connecting line of the starting and end points of it in FIG. 2:

FIG. 5 shows the input of the notch filter after processing of the original input signal of FIG. 1;

FIG. 6 shows the output of the signal in FIG. 5 after passing it to the notch filter and adjusting;

FIG. 7 shows the input of the notch filter after 5 times of processing;

FIG. 8 shows the output of the signal in FIG. 7 after passing it to the notch filter and adjusting, and the difference between the output and the signal in FIG. 1;

FIG. 9 shows the ECG signal with 50 Hz power line interference:

FIG. 10 shows the partial enlargement of the ultimate output from the input signal of FIG. 9.

### MODE OF CARRYING OUT THE INVENTION

Further explanation to the invention will be stated below combining with the

attached figures and the mode of carrying out the invention:

The present invention for the removal of power line interference, to the signal pans of which are abrupt. First, to die non-abrupt part of the original input signal, we pass it to the notch filter, and get the output as the system output. Then, to the abrupt pan, we subtract previous output from the original input signal; and add a straight line, connect the beginning and end of previous output, to the result of the subtraction to get the input of the notch filter. After processing of the notch filter, we add previous output to current output of the notch filter; and subtract the straight line as before from the sum to get the output of this step. We repeat this process several times.

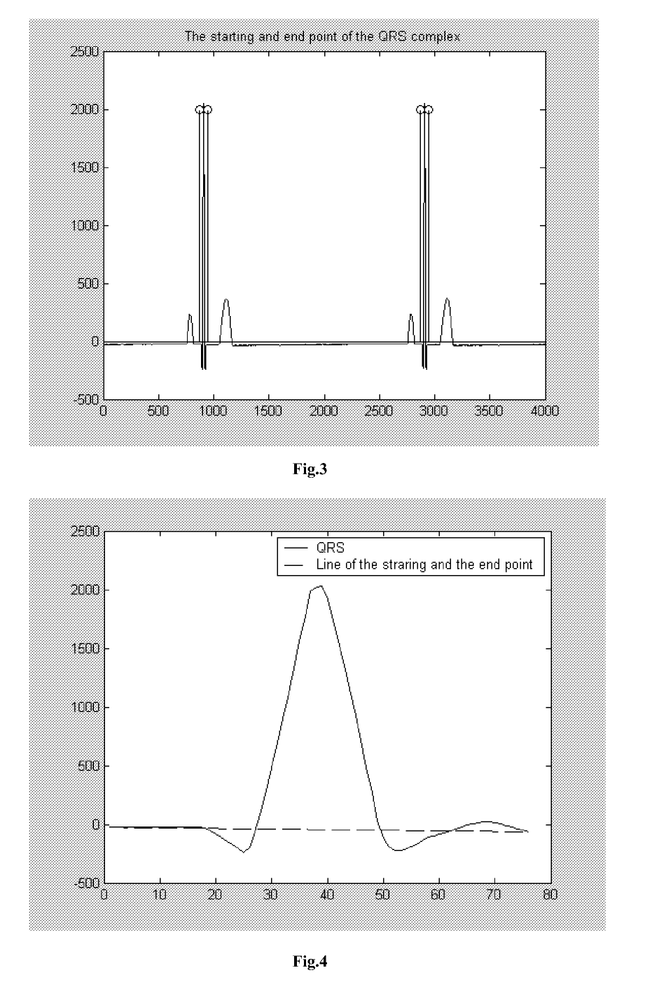

FIG. 3 is the ECG signal for processing and the localization of the starting and end points of the QRS complex for the system input signal.

As shown in FIG. 4, set the QRS complex section E_{qrs}(n)(0≦n<N) of the signal in FIG. 2 using the starting and end points of the QRS complex. According to E_{qrs}(n), make a straight line L_{qrs}(n) (0≦n<N).

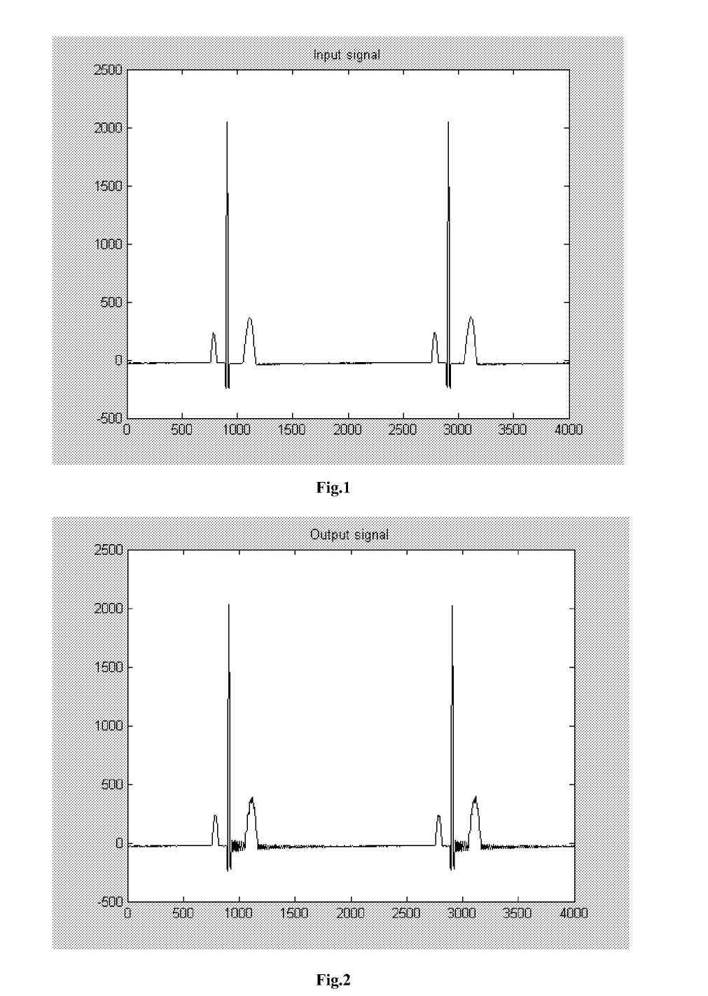

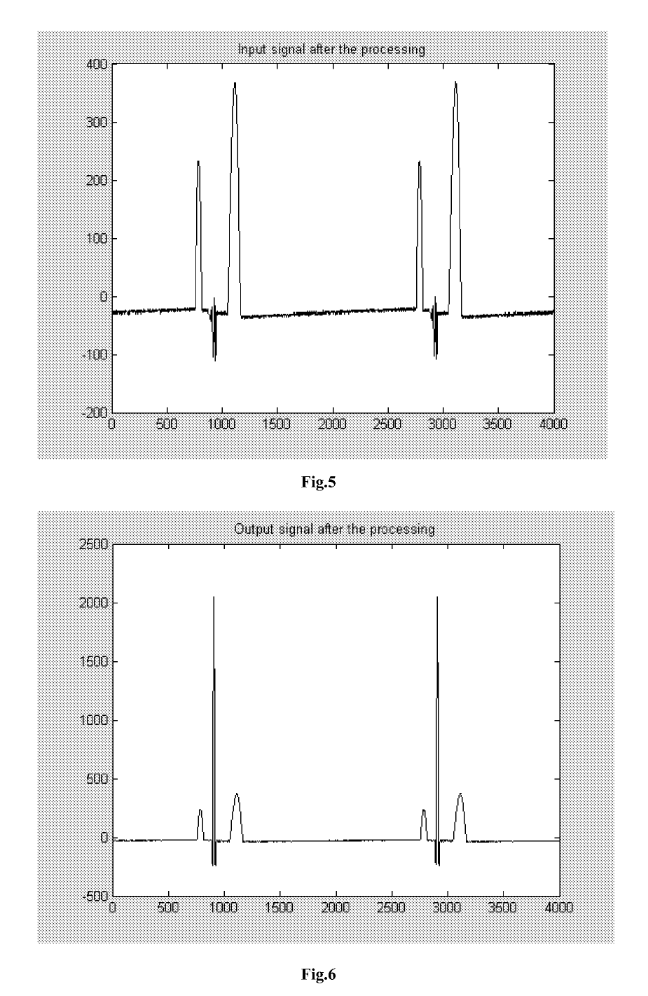

As shown in FIG. 5, use the QRS complex section in FIG. 1 minus E_{qrs}(n). (0≦N) in FIG. 4, and plus L_{qrs}(n)(0≦n<N), as the input signal of the notch filter.

FIG. 6 is the result that the output of the filter with the signal in FIG. 5 as input add E_{qrs}(n) (0≦n<N) in FIG. 4, and subtract L_{qrs}(n) (0≦n<N).

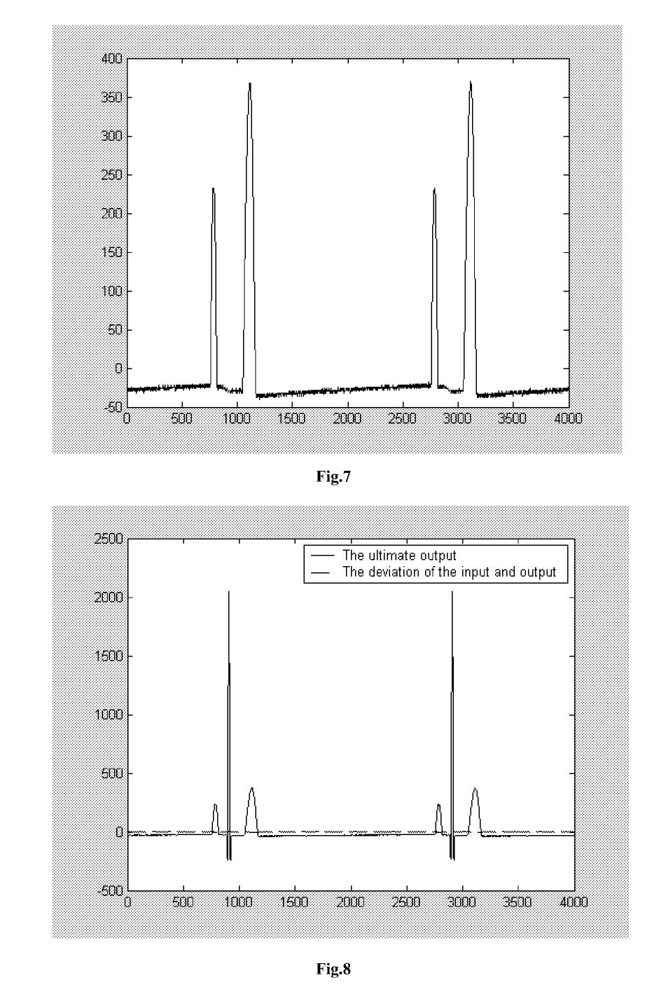

FIG. 7 is the input of the notch filter for the fifth time of processing, and clearly, the QRS complex has approximately become a straight line.

FIG. 8 is the ultimate output of the system and its deviation from the signal of FIG. 1. It is obvious that when the input is the ECG signal without power line interference, the method will not cause the ringing, so that it avoids the waveform distortion.

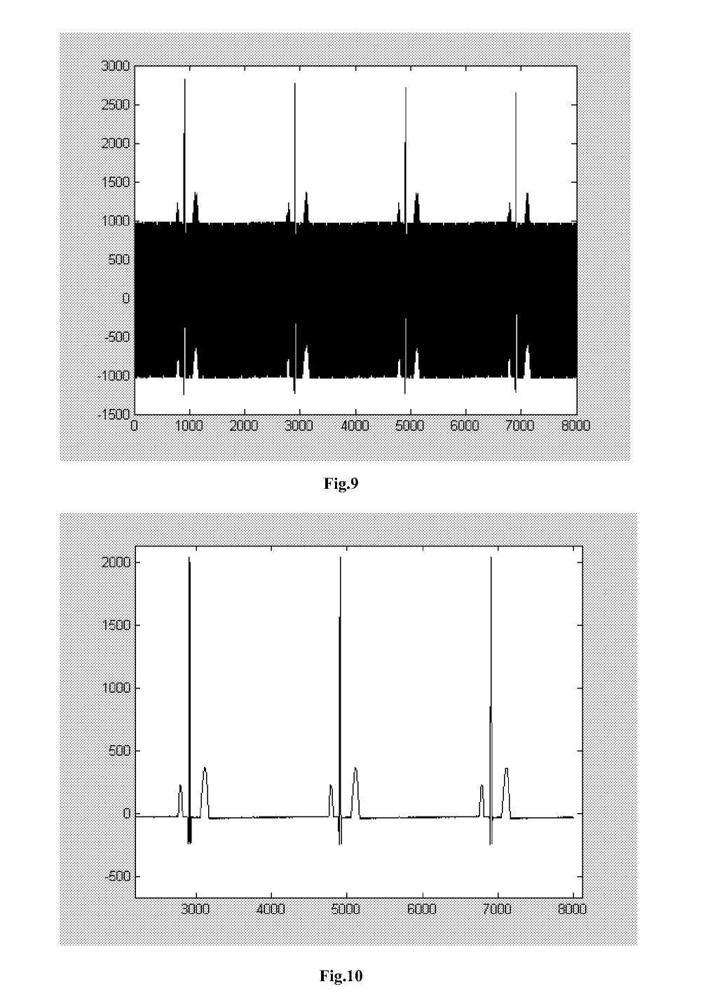

FIG. 9 uses the ECG superposed with 50 Hz sinusoidal signal as the input of the system to test the effect of filtering the power line interference of the system.

FIG. 10 is the result of the signal in FIG. 9 processed by the present method, it can be seen that the method is able to filter the PLI as well as to avoid the generation of the ringing.

The present invention is able to eliminate, the power line interference of the biomedical signals, as well as to radically avoid the generation of the ringing, which is simple and easy to implement.

1. A method for the removal of power line interference (PLI) to the signal parts of which are abrupt, wherein first, to the non-abrupt part of the original input signal, we pass it to the notch filter, and get the output as the system output; Then, to the abrupt part, we subtract previous output from the original input signal; and add a straight line, connecting the starting and end of previous output, to the result of the subtraction to get the input of the notch filter; and after processing of the notch filter, we add previous output to current output of the notch filter; and subtract the straight line as before from the sum to get the output of this step; and we repeat this processing several times.

2. The method as set forth in claim 1 characterized in that a waveform recognition is used to localize the starting and end points of the abrupt parts; as for the abrupt signals, the input of the notch filter is given by previous output and original input; the output of the notch filter is adjusted by previous output.

3. The method as set forth in claim 1 characterized in that the initial state of the notch filter should be preserved when the original signal, corresponding to the start of the abrupt, pass to the notch filter for the first time.

4. The method as set forth in claim 3 characterized in that when the original signals corresponding to the abrupt part are processed to pass to the notch filter, the initial state of the notch filter should be set as these values.

5. The method as set forth in claim 1 characterized in that the original signals corresponding to the abrupt part should be preserved.

6. The method as set forth in claim 1 characterized in that the ultimate result of the filter should be regarded as the output of the system.

7. The method as set forth in claim 1 characterized in that when the original signals are ECG, the ringing caused by the QRS complex, pace signals and high T-wave can be eliminated.
